(19) United States
(12) Patent Application Publication
(10) Pub. No.: US 2003/0059060 A1
(43) Pub. Date: Mar. 27, 2003

(54) MICROPHONE

(76) Inventors: PETER CHARLES EASTTY, OXFORD (GB); CHRISTOPHER SLEIGHT, OXON (GB); PETER DAMIEN THORPE, OXON (GB)

Correspondence Address: FROMMER LAWRENCE & HAUG, 745 FIFTH AVENUE- 10TH FL., NEW YORK, NY, 10151, US

(21) Appl. No.: 08/979,820

(22) Filed: Nov. 26, 1997

(30) Foreign Application Priority Data
Nov. 27, 1996 (GB) 9624668.1

(51) Int. Cl. H04R 1/02; H04R 3/00

(52) U.S. Cl. 381/91; 381/111; 381/92; 381/95

(57) ABSTRACT

A microphone comprises a housing; an acoustic-to-electrical signal transducer disposed within the housing, the transducer being operable to generate an analogue audio signal; and a one-bit analogue-to-digital converter disposed within the housing for converting the analogue audio signal into a one-bit digital audio signal for transmission to other, external, audio processing apparatus.

### BACKGROUND OF THE INVENTION

1. Field of the Invention

This invention relates to microphones, particularly for use in a one-bit digital audio system.

2. Description of the Prior Art

A microphone generally produces a low-level electrical signal in response to audible sound levels around the microphone. This low level electrical signal is then conducted along an electrical cable to subsequent processing apparatus-for example, a digital signal processing device such as an audio mixing console, where it is converted into a digital signal for further processing.

The low-level electrical signal is subject to induced noise and interference during transmission along the cable.

### SUMMARY OF THE INVENTION

This invention provides a microphone comprising:

a housing;

an acoustic-to-electrical signal transducer disposed within the housing, the transducer being operable to generate an analogue audio signal; and

a one-bit analogue-to-digital converter disposed within the housing for converting the analogue audio signal into a one-bit digital audio signal for transmission to other, external, audio processing apparatus.

The invention can provide a microphone for use in a one-bit digital audio system having reduced noise and distortion because the low-level microphone output signals are supplied directly to the ADC without having to pass along long lengths of cable.

If the microphone is used in an audio system employing one-bit signals throughout, it avoids the need to carry out multi-bit PCM encoding at the system's input, with the attendant loss of bandwidth, added time delay and truncation errors in conversion. In particular, the time delay resulting from a PCM encoding stage is particularly troublesome for singers wearing headphones, where some part of the sound they hear is from the microphone/ADC combination; the time delay of a typical PCM ADC is about 1 millisecond. This delay corresponds to 30 cm propagation in air, which is similar enough to the mouth-ear distance to lead to comb filtering effects.

A further feature can also alleviate any problems due to feedback, given that the audio band component of a one-bit digital audio signal is highly correlated with the input supplied to the ADC and the output of the line driver could easily be picked up by the sensitive input circuitry of the ADC.

To alleviate any such feedback problems, the one-bit signal for transmission on the coaxial cable is decorrelated from the audio signal by scrambling the digital data before supplying it to the cable driver. At the other end of the cable, a corresponding descrambler can be used.

As a further preferred feature, the scrambling process could be arranged so that if the microphone is powered down or unplugged, the descrambler (which now receives data representing a constant stream of zeroes) would generate a substantially equal distribution of ones and zeroes—a one-bit representation of digital silence.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 is a schematic diagram of a microphone;

FIGS. 2 to 4 are more detailed schematic diagrams of respective embodiments of a microphone connected to an input stage of a digital signal processing apparatus; and

FIGS. 5a and 5b illustrate a scrambler and complementary descrambler respectively.

### DESCRIPTION OF THE PREFERRED EMBODIMENTS

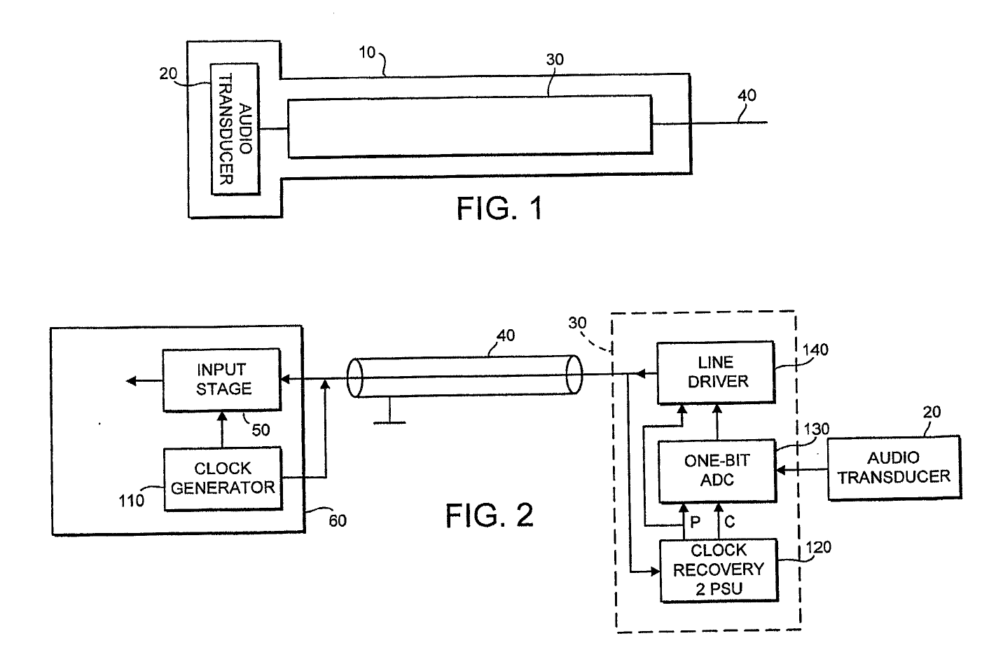

Referring now to the drawings, FIG. 1 is a schematic diagram of a microphone comprising a housing 10 in which an audio transducer (e.g. a microphone insert) 20 and a one-bit digital signal processor 30 are disposed. A transmission line such as a coaxial cable 40 carries signals from (and, in some embodiments, to) the signal processor 30.

FIGS. 2 to 4 are more detailed schematic diagrams of respective embodiments of the microphone connected to an input stage 50 of a digital signal processing apparatus 60.

In FIGS. 2 to 4, the following reference numerals are used to denote similar, though not identical, parts:

30, 30′, 30″ digital signal processor within the microphone housing

50, 50′, 50″ input stage

60, 60′, 60″ digital signal processing apparatus

The digital signal processing apparatus 60 could be, for example, an audio mixing console or effects unit operable to process one-bit digital audio signals.

Starting therefore with FIG. 2, the signal processing apparatus 60 includes a clock generator 110 which generates a clocking signal to which the one-bit digital audio signal from the microphone is to be synchronised. The clock generator supplies the clock signal to the input stage 50 and also, via the coaxial cable 40 (but in a “reverse” direction), to a clock recovery and power supply unit 120 within the signal processor 30 of the microphone.

The clock recovery and power supply unit 120 generates two output signals: one is a straightforward clocking signal supplied to a one-bit analogue-to-digital converter (ADC) 130, and the other is a power output which supplies operating power to the one-bit ADC 130, a line driver 140 and (if necessary) the audio transducer 20.

The power supply is derived from the clocking signal carried by the coaxial cable 40 by rectifying and smoothing the clocking signal. This avoids the need for a conventional “phantom power” arrangement, although conventional phantom power could be used instead if desired.

In operation, therefore, the audio transducer 20 generates an analogue-audio output signal dependant on sound levels in the vicinity of the audio transducer 20. The one-bit ADC 130 converts the analogue signal into a one-bit digital signal in accordance with the clock supplied from the clock recovery and power supply unit 120. The line driver 140 then amplifies the output of the one-bit ADC 130 to a suitable level for transmission via the coaxial cable 40.

At the digital signal processing apparatus 60, the input stage (synchronised by the clock generator 110) terminates the coaxial cable 40 and “cleans up” the waveform of the digital signal transmitted via the coaxial cable 140 by using a thresholder (e.g. a Schmidt trigger) to detect whether the signal on the coaxial cable 40 is above or below a threshold signal level, thereby generating a “clean” digital output for subsequent processing.

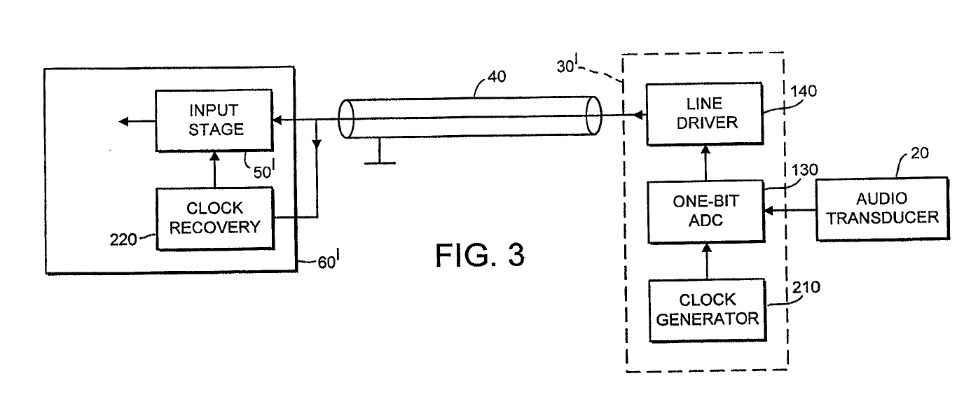

A second embodiment is illustrated in FIG. 3, where the digital signal processing 30′ includes a clock generator 210 which supplies a clocking signal to the one-bit ADC 130 as before. Also, as in FIG. 2, the line driver 140 amplifies the output of the one-bit ADC 130 to a suitable level for transmission along the coaxial cable 40.

In FIG. 3, the clock generator 210, the one-bit ADC 130, the line driver 140 and (if necessary) the audio transducer 20 are powered either by batteries or by conventional phantom powering.

At the recipient digital signal processing apparatus 60, the signal on the coaxial cable 40 is passed to a clock recovery unit 220 which recovers the clocking rate of the one-bit digital signal by synchronising a phase-locked-loop to the bit rate of the one-bit signal. The input stage 50′ is synchronised by the output of the clock recovery unit 220.

A further synchronising stage may be required if the one-bit signal from the microphone is to be processed along with one-bit signals synchronised to other clocking sources (e.g. from other microphones).

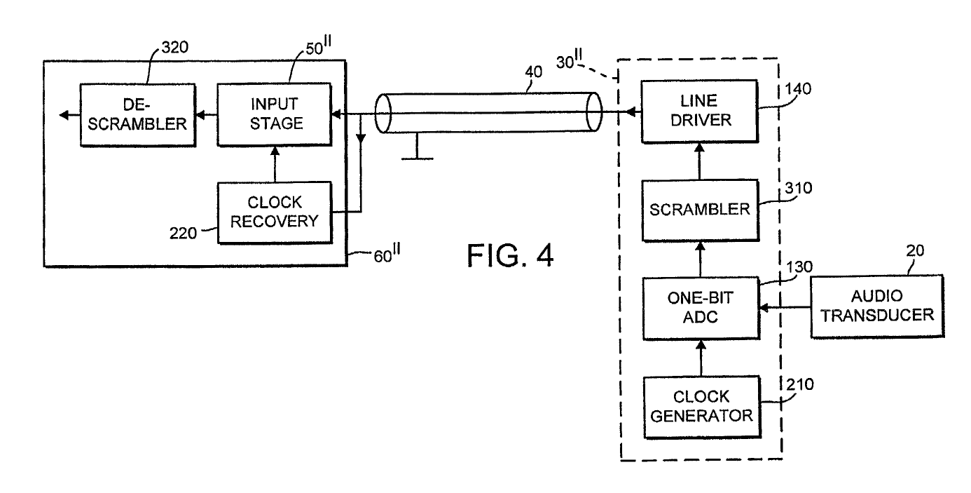

FIG. 4 illustrates a third embodiment which addresses three potential problems with the embodiment of FIG. 3.

These problems are (i) it not always easy to recover a clocking signal from a one-bit digital audio signal; (ii) since a low-pass filtered version of a one-bit digital audio signal can be considered as a representation of the analogue audio signal, there is the danger that the relatively high signal levels output from the line driver 140 will be fed back (e.g. by induction) to the relatively low signal level input of the one-bit ADC 130, leading to possible feedback problems potentially causing non-linear distortion; and (iii) if the microphone is unplugged or powered down, the thresholder in the input stage 50 could output a continuous sequence of the same bit value (e.g. zero)—which represents a very large signal level indeed in the one-bit digital domain.

These potential problems are addressed in the embodiment of FIG. 4 by incorporating a status scrambler 310 in the microphone and a corresponding de-scrambler 320 at the recipient digital signal processing apparatus.

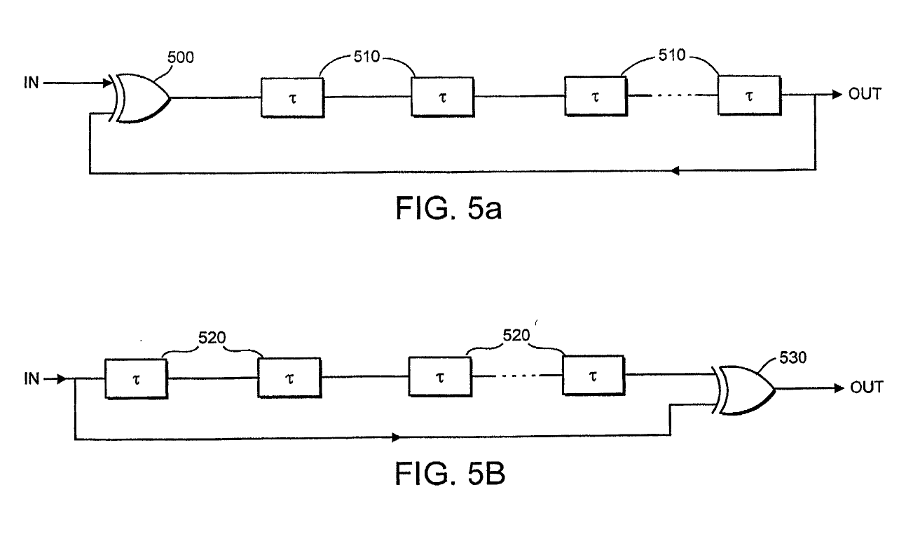

The scrambler 310 and de-scrambler 320 will be described in detail below with reference to FIG. 5, but, briefly, their purpose is to ensure that the data transmitted along the coaxial cable 40 is relatively de-correlated from the audio signal supplied to the one-bit ADC 130. This can reduce the problems of feedback between the output of the line driver 130 and the input to the one-bit ADC 130. Also, the digital content of the data signal can be changed so that it is easier for the clock recovery circuit 220 to recover a clocking signal from the scrambled signal.

FIG. 5a schematically illustrates one embodiment of the scrambler 310, and FIG. 5b schematically illustrates one embodiment of the complementary descrambler 320.

In FIG. 5a, the signal to be scrambled is supplied as one input to a two-input exclusive-OR gate 500. The output of the exclusive-OR gate 500 is fed through a series of n one-bit delays 510—where n could be, for example, between 8 and 16. The output of the final delay of the chain forms the scrambled data output and is also fed back to provide the second input to the exclusive-OR gate 500.

Similarly, in FIG. 5b, the input data to be descrambled is supplied in parallel to the first of a chain of m one-bit delays (where m is the same as the value of n in FIG. 5a) and to one input of a two-input exclusive-OR gate 530. The other input of the exclusive-OR gate 530 receives the output of the chain of delays 520. The output of the exclusive-OR gate 530 forms the descrambled data.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim

1. A microphone comprising:
a housing;
an acoustic-to-electrical signal transducer disposed within said housing, said transducer being operable to generate an analogue audio signal; and
a one-bit analogue audio signal into a one-bit digital audio signal for converting the analogue audio signal into a one-bit digital audio signal for transmission to other, external, audio processing apparatus.

2. A microphone according to claim 1, comprising a clock generator for generating a clocking signal to synchronise operation of the analogue-to-digital converter.

3. A microphone according to claim 1, comprising means for receiving a clocking signal from external apparatus.

4. A microphone according to claim 3, comprising means for deriving a power supply signal from said received clocking signal, and for supplying said power supply signal to said analogue-to-digital converter.

5. A microphone according to claim 4, in which said deriving means comprises a rectifier and a smoothing circuit.

6. A microphone according to claim 1, comprising a data scrambler for scrambling said data generated by said analogue-to-digital converter so that the correlation between said scrambled data and said analogue audio signal is lower than the correlation between said output data of said analogue-to-digital converter and said analogue audio signal.
